(19) United States
(12) Patent Application Publication
(10) Pub. No.: US 2019/0318316 A1
(43) Pub. Date: Oct. 17, 2019

(54) Mobile Application for Staffing Suppliers

(71) Applicant: PRO Unlimited Global Solutions, Inc., Boca Raton, FL (US)

(72) Inventors: Ted Sergott, Moraga, CA (US); Nataliya Kolb, San Francisco, CA (US)

(21) Appl. No.: 16/382,112

(22) Filed: Apr. 11, 2019

Related U.S. Application Data
(60) Provisional application No. 62/656,878, filed on Apr. 12, 2018.

(51) Int. Cl. G06Q 10/10; H04L 12/18

(52) U.S. Cl. CPC G06Q 10/1053; H04L 12/1813; G06Q 10/1091

(57) ABSTRACT

The present invention is directed to systems and methods for providing a staffing sourcing platform providing recruitment services and recruitment-related services. Further, the staffing platform provides virtual managed services in real-time permitting suppliers and candidates to perform multiple mobile-based and web-based tasks. In particular, users are permitted to manage new staffing requests, interview scheduling and expense management in real-time.

### RELATED APPLICATIONS

This application claims priority from the U.S. provisional application Ser. No. 62/656,878, which was filed on Apr. 12, 2018. The disclosure of that provisional application is incorporated herein as if set out in full.

### FIELD OF THE INVENTION

The present invention is directed to systems and methods for providing recruitment services and/or recruitment-related services as they may relate to suppliers, hiring managers and/or hiring entities, in a network environment.

### BACKGROUND

Multiple personnel may be involved in the hiring process of an employee.

Larger businesses, companies, etc., may have human resources departments that are responsible for managing staff as well as other employee-related issues. Smaller businesses may subcontract HR work to outside recruiting firms or may delegate the staffing responsibilities to higher-level executives or managers. In either case, the hiring process may be costly and time-consuming due to the relatively high wages paid to personnel with human resource training.

Thus, freelance staffing suppliers in the modern era are often inundated with work, including files covering hundreds of candidates applying for positions in a diversity of fields. Particularly in times of economic stress where very large numbers of candidates may be seeking a small number of openings, the review process can tax even the most experienced staffing supplier. As a consequence, the demand for low-cost and efficient automated means of matching suitable candidates with job openings has grown.

Even with the assistance of software systems, the challenge of matching suitable candidates with job openings remains substantial. During the screening process, for example, qualified candidates may be erroneously removed from an initial pool of candidates due to human error. While hiring managers often intend to remove many candidates from such pools due to, for example, lack of qualifications, incompatible location, experience, or education, it is also a common occurrence that hiring managers and suppliers are overwhelmed with data and thus cannot carefully isolate the most appropriate candidates for a position. Further, the speed at which technology-savvy staffing suppliers move from candidate identification to filling a job opening increases every day. Correspondingly, for most employers it is critical to rapidly identify suitable candidates for a given position given increased cost-pressures in the modern era.

One key to the successful utilization of candidate, supplier and hiring company data is to recognize the wide variety of information that is now made available. Achieving new methods of analyzing said data, automating access to said data, and the like, may facilitate the matching of candidates with job openings.

For the foregoing reasons there is a need for the staffing platform of present invention, which is uniquely designed to interact with staffing suppliers, candidates, and other users in order to provide a staffing platform that manages new staffing requests, interviews, expenses in an automated and mobile-adaptable fashion.

### SUMMARY OF THE DISCLOSURE

To minimize the limitations found in the existing systems and methods, and to minimize other limitations that will be apparent upon the reading of this specification, the preferred embodiment of the present invention provides methods and systems of providing mobile and web-based virtual managed services in a job recruitment context.

The present invention is directed to systems and methods of providing virtual managed services in real-time, allowing suppliers and other recruitment personnel to perform multiple mobile-based and web-based actions in real-time. This invention addresses several problems that persists in the field: that human resources personnel, employees, staff and building management personnel are often overwhelmed with information and tasks that may be easily automated with software and hardware systems. Further, the speed at which hiring technology-savvy suppliers search for candidates, manage staffing requests, and schedule interviews is increasing every day.

Each of these issues may be facilitated by the present mobile and web-based staffing platform system and methods which leverage machine learning and interactive functionalities to allow users to perform multiple actions. Such methods and systems facilitate new staffing requests, interview scheduling, and expense management.

In the first instance, the staffing platform comprises enrollment of users, enrollment of candidates, receiving new staffing requests from users via a new staffing request page, creating job requirements for users based on the information provided in the new staffing requests, receiving profiles from candidates, and matching the profiles with the job requirements. In some embodiments, the method for providing a staffing platform also includes providing an integrated interview scheduling feature in the staffing platform allowing the candidates and the users to arrange interview times and/or locations. In some embodiments, the staffing platform provides an integrated calling and chatting feature, allowing the candidates and the users to connect. In further embodiments, the staffing platform provides an expense management feature, based on candidate and staffing supplier expenses in addition to hiring entity approval or denial of said expenses. In yet another embodiment, the staffing platform tracks various candidate activities and user activities, providing updates to the candidates and the users, based on said tracking.

A first objective of the present invention is to provide a means to enhance job management efficiencies for users, staffing suppliers, hiring recruiters, hiring managers and other hiring entities.

A second objective of the present invention is to provide a means by which candidates can connect more efficiently with potential employers, through various media platforms.

A third objective of the present invention is to provide a means of focusing recruiter attention on securing interviews for candidates with the requisite skills required for a given job opportunity.

A fourth objective of the present invention is to provide a means for staffing suppliers and other job recruitment staff to track and manage new staffing requests in real-time.

A fifth objective of the present invention is to provide a means for staffing suppliers and other job recruitment staff to track and manage interview scheduling in real-time.

A sixth objective of the present invention is to provide a means for suppliers and hiring entities to track and manage expenses in real-time.

These and other advantages and features of the present invention are described with specificity so as to make the present invention understandable to one of ordinary skill in the art. In addition, these and other features, aspects, and advantages of the present invention will become better understood with reference to the following description.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus the drawings are generalized in form in the interest of clarity and conciseness.

FIGS. 1A-1D are screenshots detailing the interview scheduling functionality of the staffing platform according to an embodiment;

FIGS. 2A and 2B are screenshots detailing the expense management functionality of the staffing platform according to an embodiment.;

FIG. 3 is a screenshot detailing the new staffing request functionality of the staffing platform according to an embodiment;

FIG. 4A and 4B are screenshots showing a mobile phone lock screen receiving real-time information without the need for a user to log in to the staffing platform application according to an embodiment;

FIGS. 5A-5C are screenshots showing a propose new interview time screen;

FIG. 6A and 6B are screenshots showing a global position and candidate search in progress as well as additional details regarding a position;

FIG. 7 is a screenshot showing the text message option for communication across the platform; and

FIG. 8 shows an application installation on a mobile device, with 15 updates pending.

### DETAILED DESCRIPTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

The present invention comprises information processing systems and methods to provide staffing suppliers with a staffing platform for automated job management. Typically, a staffing platform is an electronic network where staffing suppliers exchange and analyze information pertinent to candidate hiring. In some embodiments, a staffing platform is a network of computing devices that allows staffing suppliers and other users to exchange information about potential job candidates. The computing device of the present invention is configured with a non-transitory computer-readable medium (also referred to as an application). Further, this application is functional both as a web application (including websites, portals, plugins etc.) and as a mobile application, thereby permitting staffing suppliers and candidates to benefit from the application in a variety of settings.

The present invention, also referred to herein as a staffing platform or mobile staffing application, comprises a component of a VMS (Virtual Managed Services) system. In some embodiments, the staffing platform allows users to perform several functions including tracking and managing new staffing requests, tracking and managing interview scheduling, and tracking and managing expense approval in real-time. Users of the present invention generally include staffing suppliers and hiring entities. Staffing suppliers may comprise recruiters, staffing companies, freelance suppliers, lay users, and the like. Hiring entities may comprise hiring managers, administrators, managers, and the like.

As described above users may include staffing suppliers. Staffing suppliers work to fill job openings in businesses or organizations. The most common staffing supplier is a recruiter, who reviews candidate resumes, reviews candidate interview material, negotiates salaries, and ultimately places candidates in agreeable employment positions. There are various categories of recruiters. For instance, headhunters, executive recruiters, internal recruiters, Information Technology recruiters and so on. Regardless of recruiter category or classification, all recruiters search for qualified candidates and attempt to connect those candidates with suitable employment opportunities. Typically, in order to carry out this function recruiters create a list of the most qualified job seekers and present the list to a hiring manager. Traditionally, hiring managers identify candidates using said recruiter lists and manage the recruitment process from the employer's perspective, including scheduling of interviews, management of expenses, submitting new staffing requests, and the like.

The present invention comprises a staffing platform that provides users a single web-based and mobile-based application that enables users to process job applications and various other job recruitment information simultaneously. The staffing platform is compatible with a variety of operating systems including iOS, Android and other operating systems known in the art.

In the preferred embodiment, the method for providing a staffing platform initially comprises enrollment of users, enrollment of candidates, receiving new staffing requests from users via a new staffing request page, creating job requirements for users based on the information provided in the new staffing requests, receiving profiles from candidates, and finally matching the profiles with the job requirements. In some embodiments, the method for providing a staffing platform also includes providing an integrated interview scheduling feature, thereby allowing the candidates and the users to arrange interview times and/or locations. Interviewees are provided with potential interview time slots, and select their preferred time and location for the interview via the staffing platform.

In some embodiments, the staffing platform provides an integrated calling and chatting feature, allowing the candidates and the users to connect. In other embodiments, the staffing platform provides an expense management feature based on candidate and staffing supplier expenses. Hiring entities and/or staffing suppliers utilize the staffing platform to approve of or deny said expenses. In yet another embodiment, the staffing platform tracks various candidate activities and user activities, providing updates to the candidates and the users, based on said tracking. Candidate activities may include email activity, chat activity, updates to resumes, and the like. User activities may include frequency of external supplier use, average duration a position has remained open, and the like.

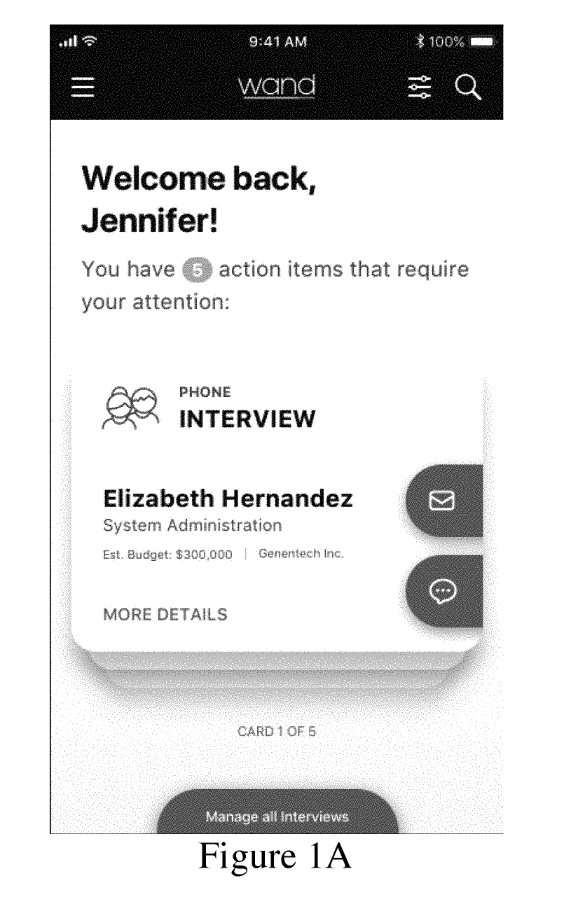

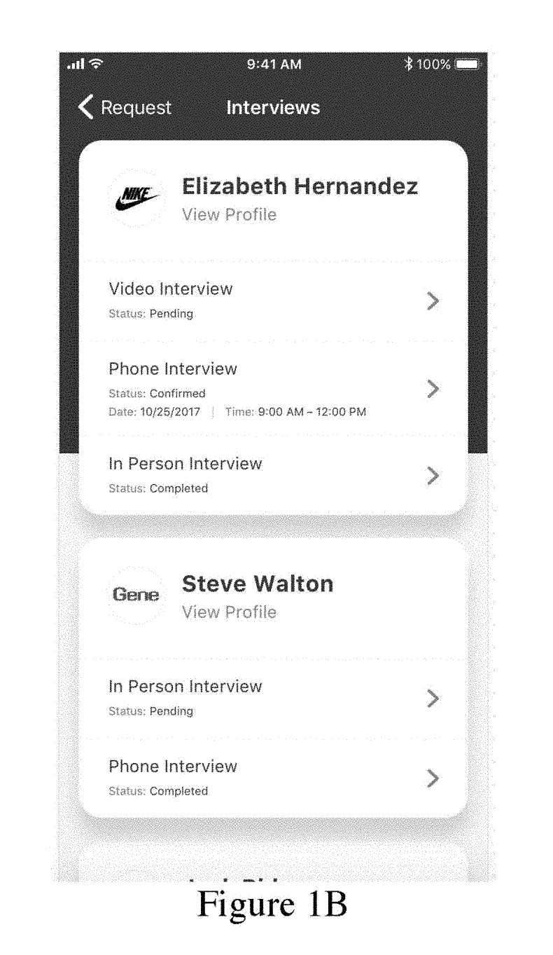

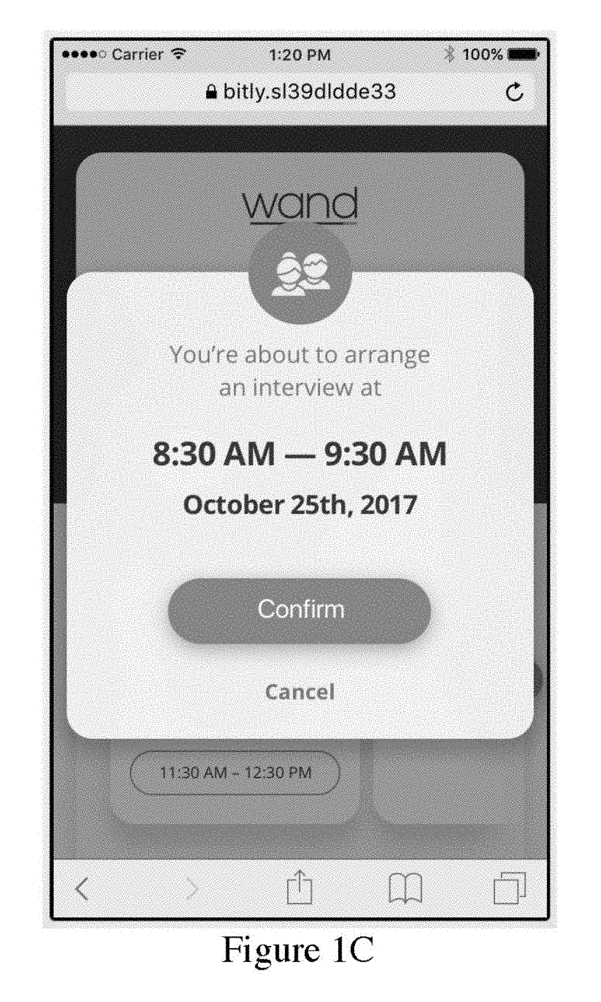

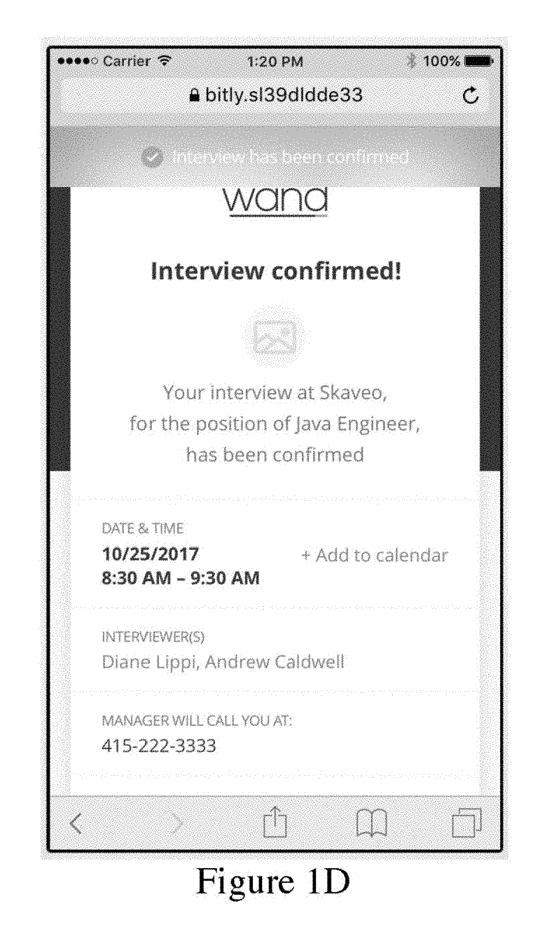

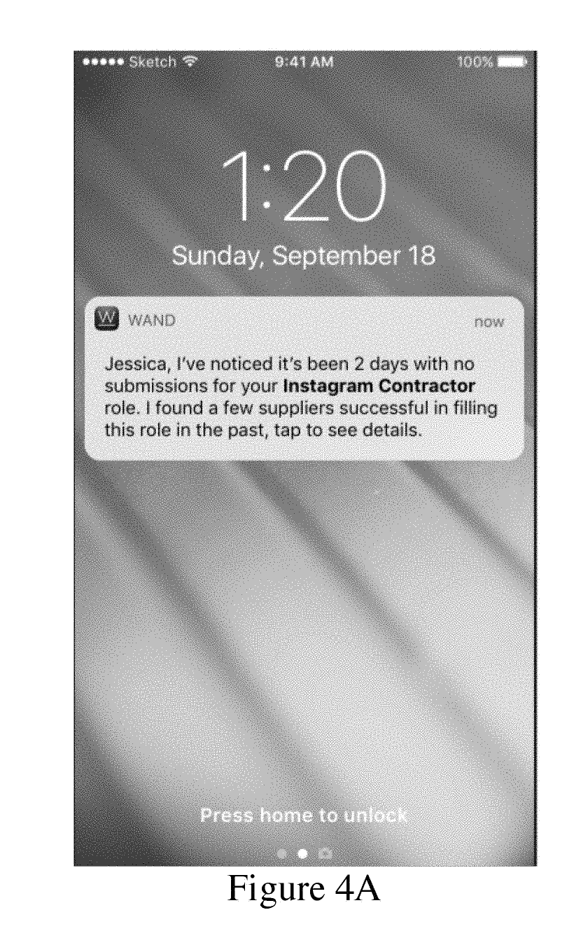

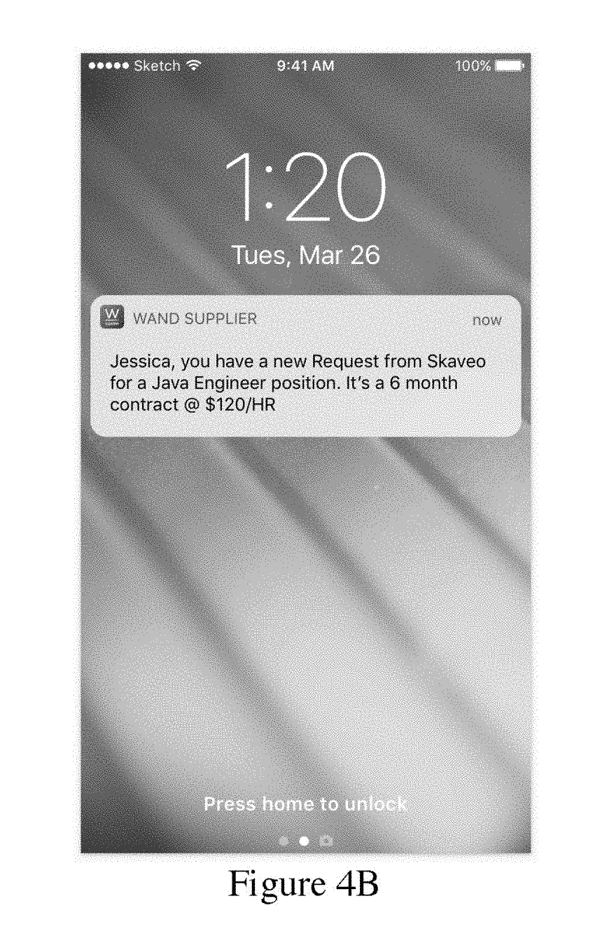

Referring to FIGS. 1-4, a mobile application for staffing suppliers is shown. Notably, the present invention also contemplates a web-based application for staffing suppliers. Referring to FIGS. 4A and 4B, in the preferred embodiment the staffing platform is capable of providing real-time notifications to users regarding job management information without the need to log in to the application itself. In other words, notifications are visible from a user's mobile “lock screen” without the need for a user to unlock his or her phone. Job management information shown on the lock screen may comprise new staffing requests, interview scheduling, expense management, external supplier information, and the like.

As mentioned above, as an initial step, users must engage in account enrollment on a user account enrollment page in order to utilize the staffing platform system. In some embodiments, account enrollment for users may include the following: user identification information is inputted, user contact information is inputted, a unique Email ID is generated, a password is created, and the like. In some embodiments, the Email ID may be used for tracking the users and for other contextual aspects of the staffing platform system. In some embodiments, staffing suppliers may post jobs on a variety of external staffing platforms with this unique Email ID.

In addition, candidates must engage in account enrollment on a candidate account enrollment page in order to utilize the staffing platform system. In some embodiments, account enrollment for candidates may include the following steps: candidate identification information is inputted, a unique Email ID is generated, a password is created, and the like. In some embodiments, the Email ID may be used for tracking the candidates and for other contextual aspects of the staffing platform system. In some embodiments, candidates may post resumes on a variety of external staffing platforms with this unique Email ID. Once a candidate submits a resume and carries out the several steps listed above, a new account will be created for the candidate.

Regarding the new staffing request functionality of the present invention, the staffing platform is capable of providing new staffing requests from users via a new staffing request page. The new staffing requests are transmitted and processed in real-time on both mobile and web-based devices. In some embodiments, the new staffing request page provides users with job requisition information. Job requisition information may include absolute requirements for a given position including, for example, a required number of years of managerial experience, educational degrees, professional licenses, and the like.

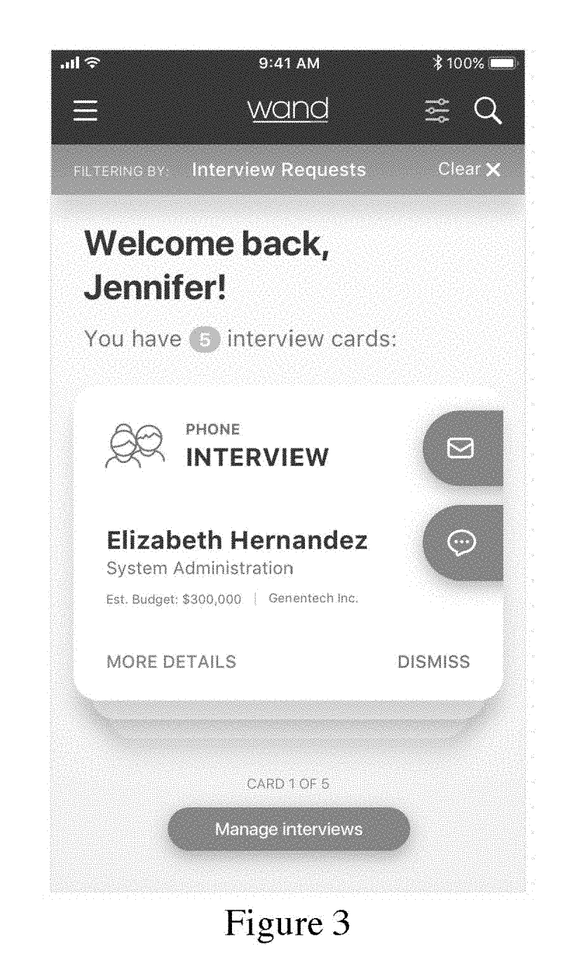

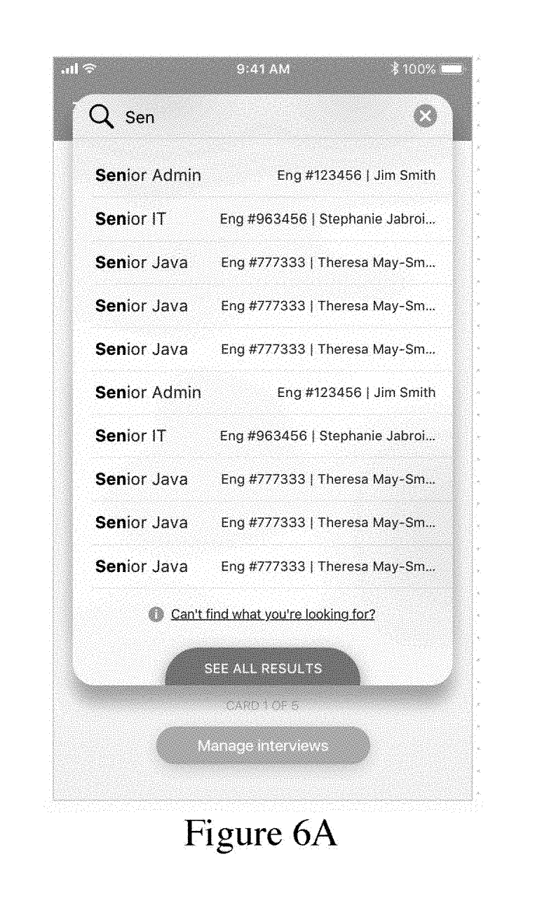

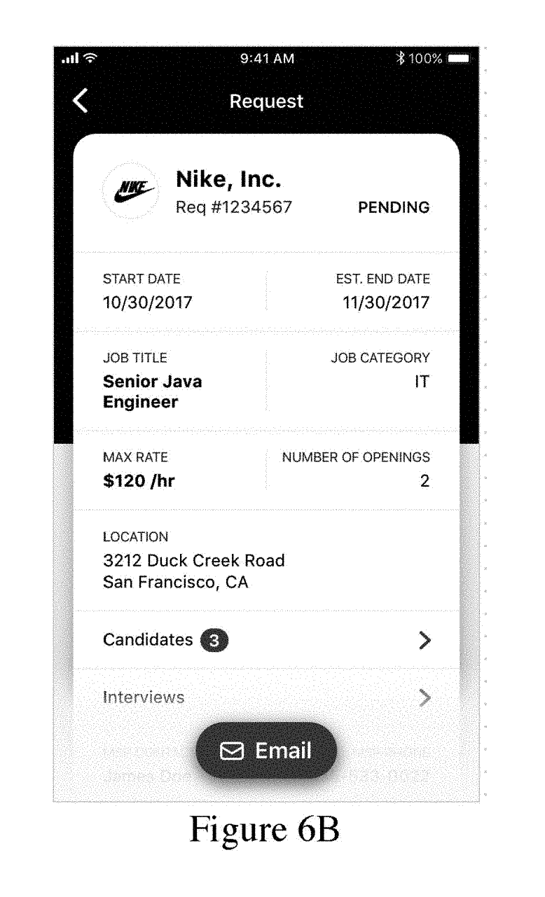

Referring to FIG. 3, the new staffing request page may further comprise candidate profiles, hiring entity names, duration of the requested contract, hourly billable rates, the number of open positions, position titles, position locations, alternate potential employer locations, number of action items requiring the user's attention, selectable search icons, selectable search filter icons, selectable email icons, links to more details, and the like. The requisition details accessible from said screen may be forwarded via email and other messaging services common in the art. As described above, the staffing platform of the present invention comprises both a job requisition review feature and job requisition forwarding feature, the later allowing the users to forward job requisition details to other users in a secure manner. In yet another embodiment of the new staffing request functionality, the ability to view pending and completed interviews is available. The platform can also provide a global search for positions and interviewers as shown at FIGS. 6A and 6B.

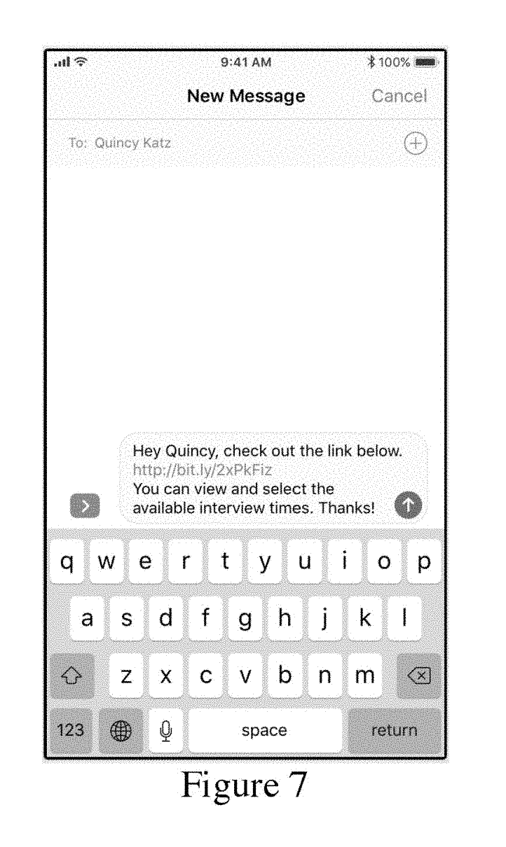

Regarding the integrated interview scheduling feature of the present invention, the staffing platform is capable of providing real-time information regarding interview scheduling on a mobile or web-based device. In the preferred embodiment, the integrated interview scheduling feature allows users to send up to five potential interview time slots to candidates. Notably, the present invention contemplates sending more than five interview time slots to a given candidate in some embodiments. In other embodiments, the integrated interview scheduling feature allows users to choose their own time slots for an interview in real-time. In addition, the integrated interview scheduling feature allows candidates to email, text, or SMS chat with staffing suppliers regarding the interview times and locations, as shown at FIG. 7. In some embodiments, the interview scheduling feature allows candidates to choose their preferred interview times or locations via the staffing platform.

Further to the interview scheduling feature, once an interview time slot is chosen by a given candidate the user then receives the candidates preferred times and/or locations via an interview notification module. The interview notification module alerts users to the chosen interview time and date via text message, SMS chat, email, or via a interviewing scheduling page. In some embodiments, this interview notification information is shared with all three parties via a shared calendaring system. In some embodiments of the staffing platform, the integrated interview scheduling feature also includes a follow-up tool wherein candidates and users are able to arrange for a follow-up recruiter meeting time and location, if needed. Notably, compatible calendaring systems that may integrate with the interview scheduling features above comprise Outlook Calendar, Google Calendar, and similar shared calendaring systems known in the art.

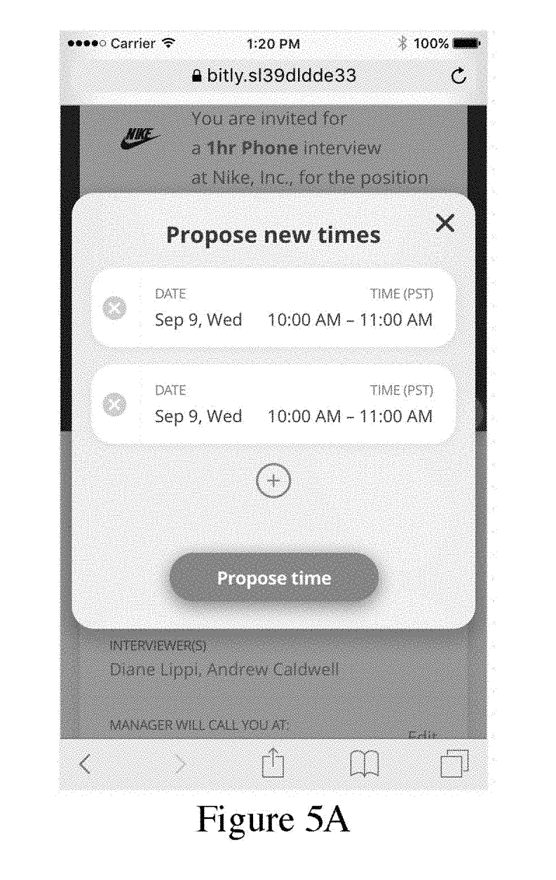

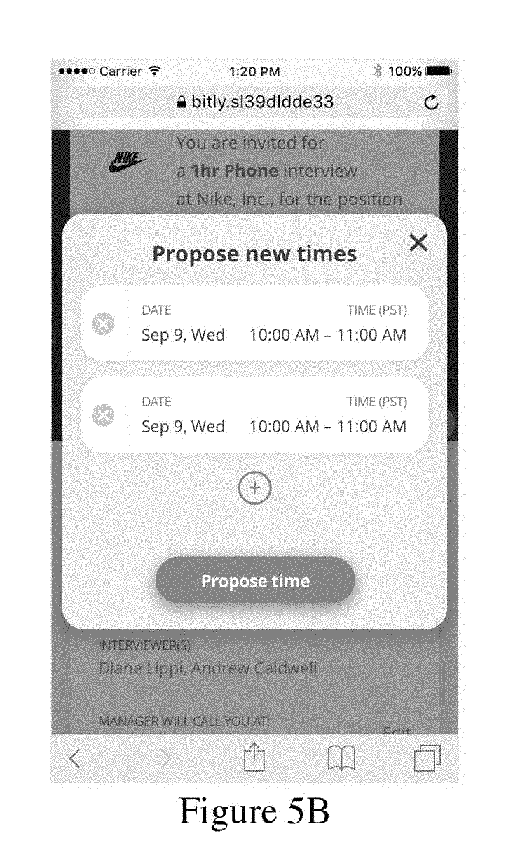

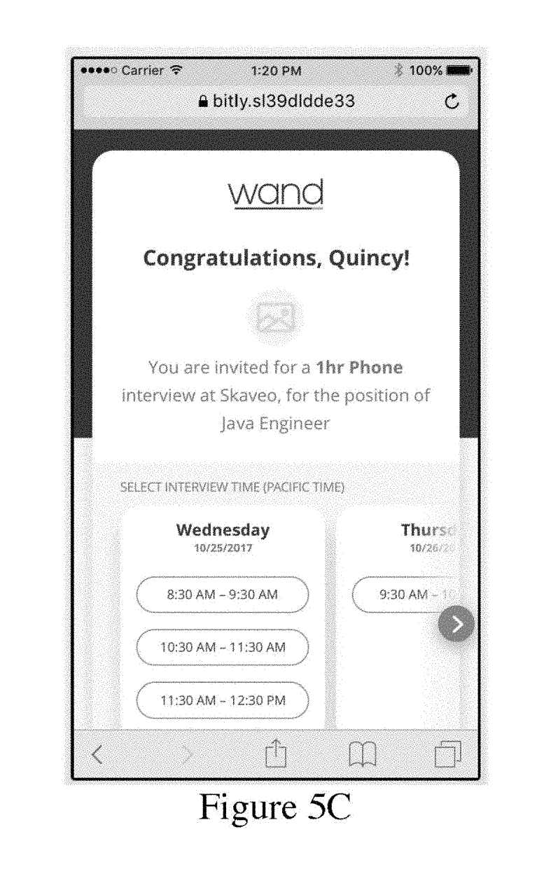

As further shown in FIGS. 1A-1D, the interview scheduling functionality of the staffing platform may permit display of the number of potential interview times provided to a candidate, the interview category (comprising phone interviews, and/or in-person interviews, and/or group lunches, and the like), the number of open related positions, in addition to the name of the hiring entity. Further, the staffing platform may display the position title for the open position, the allocated budget, the interview time, the interview location, alternate position locations, the number of action items requiring the user's attention, selectable search icons, selectable search filter icons, selectable email icons, links to more details, and the like. In some embodiments, the application is capable of displaying real-time notifications regarding interview times and the like without the need to log in to the application. As shown at FIG. 5A, the candidate may propose a new time for the interview. As shown at FIG. 5B, the proposed new time is proposed to the interviewer, who may either accept or reject. Once the meeting is scheduled, the platform displays to the interviewee details regarding the upcoming interview, as shown at FIG. 5C.

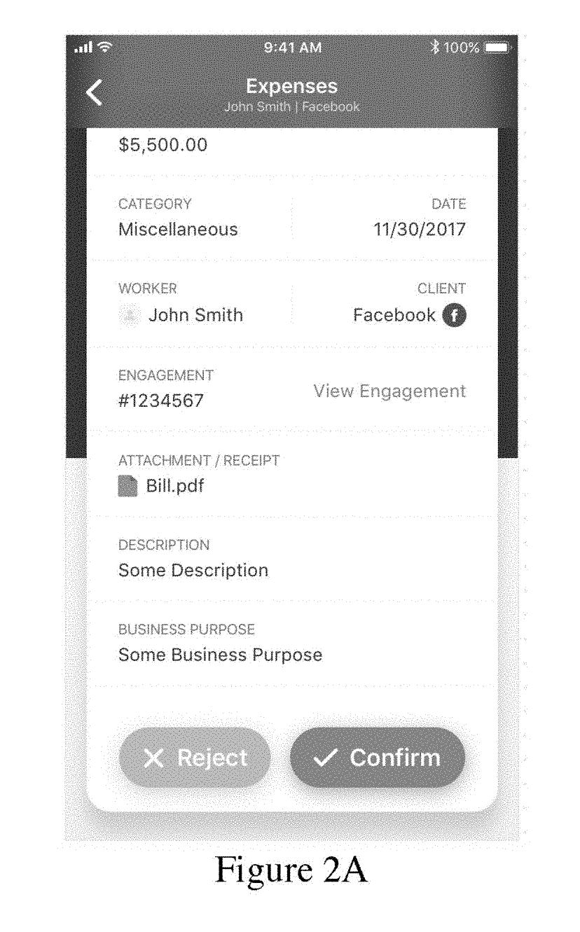

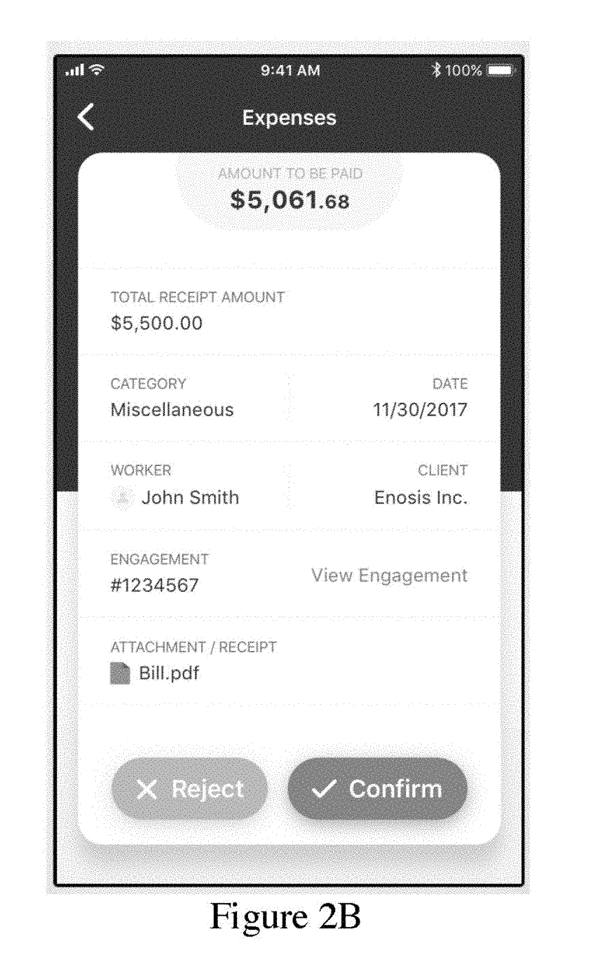

Regarding the expense management feature of the present invention, the staffing platform displays real-time notifications regarding candidate and staffing supplier expenses on both mobile and web-based devices. As shown in FIGS. 2A and 2B, the expense management feature comprises information regarding the expense category, the name of spender, payments executed, reference numbers, and the hiring entity or other entity responsible for covering the expenses. The expense category includes candidate expense information related to food and/or hotel and/or gas and/or flight and/or uncategorized expenses, and the like. In some embodiments, users can view receipts, and exchange copies of the receipts with interviewees during follow-up recruiter meetings, if necessary. In some embodiments, the application is capable of displaying real-time notifications on a user's mobile lock screen such as new expenses logged without the need to log in to the application.

As noted above, the present invention contemplates a calling and chatting feature relevant to all of the job recruitment features herein described, including new staffing requests, integrated interview scheduling, and expense management. In the preferred embodiment, the staffing system integrates SMS, email, and texting buttons into each display page, allowing the candidates and the users to connect instantly. Referring to FIG. 1A, for example, a welcome page displaying interviewee information includes user-selectable buttons enabling email and chat features.

Regarding the supplier search and filter functionalities of the present invention, the staffing platform provides real-time data-driven tools for users to filter their action items. In some embodiments, the supplier and search filter functionalities permit users to select from a variety of functions including, but not limited to: select all, requests, interviews, and/or expenses. Further, in some embodiments, suppliers can search the application by name, requisition number, engagement number, and/or other filters commonly used in the art.

As described above, in some embodiments the present invention comprises an information processing system and/or staffing sourcing system in a job recruitment environment. In one embodiment, said information processing system may be summarized as a system comprising a server connected to a network, wherein the server receives requests from users via a network. This server may include a processor(s), a database for storing candidate information, and a memory operatively coupled to the processor. In some embodiments of the present invention, memory stores program instructions that when executed by the processor, causes the processor to receive new staffing requests from a user via the network. Logistical interview information is generated from the candidate database based on the new staffing request. Finally, the potential interview times and locations are transmitted to the user via the network.

Referring further to the staffing sourcing system described above, the candidate information database comprises a database of information comprising candidate availability, candidate hard skills, candidate soft skills, candidate billing rates, candidate geographical preferences, automated candidate recommendations, and the like. Logistical interview information comprises at least potential interview dates feasible for candidates, potential interview times feasible for candidates, geographical information, hotel preferences, and the like.

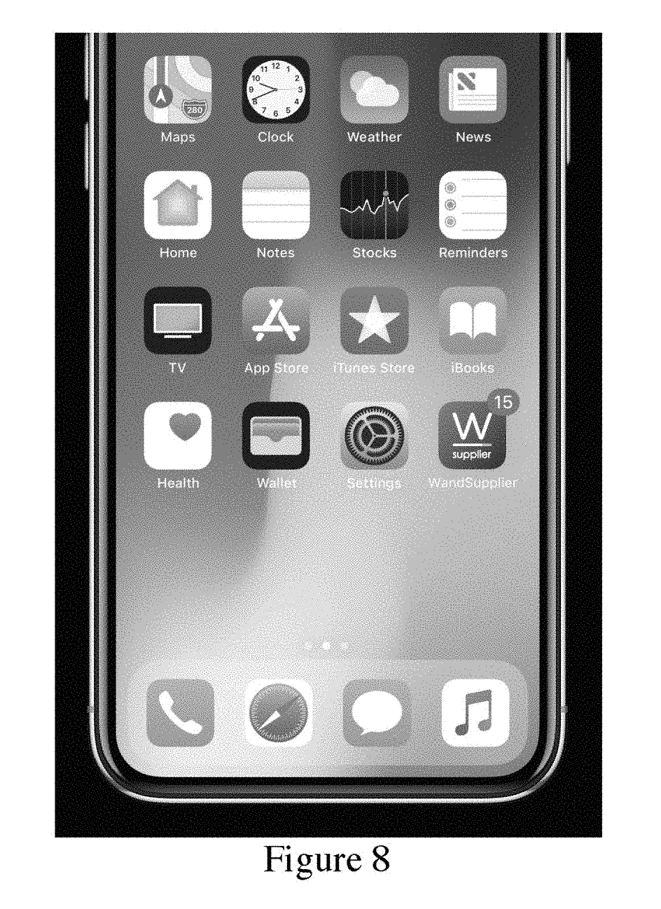

As described above, the present invention is an application capable of displaying real-time notifications a mobile device and/or website. A mobile device may be a wireless mobile device or any type of portable computer device, including a cellular telephone, a Personal Digital Assistant (PDA), smartphone, etc. By way of example only, and not by way of limitation, smartphones contemplated by the present invention include Apple's iPhone series (see FIG. 8), Google's Droid and Nexus One series, Palm's Pre series, and RIM's Blackberry series of smartphones. In some embodiments, mobile devices comprise a camera, a processor, a graphical user interface (GUI), and a memory. In embodiments, the memory is operatively coupled to the processor and stores program instructions that when executed by the processor, causes the processor to receive an image from the camera. Said image may be displayed on the GUI. The GUI may also receive descriptive data for the image and store the descriptive data and image as a listing. Generally, said listing may be transmitted wirelessly to a host server. Further, the mobile device may comprise a display, a GPS module, a compass, a camera and various other input/output (I/O) components.

As described above, the present invention relates to information processing methods and systems in a job recruitment environment. Said system can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random-access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet 20 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for providing a staffing platform for automated job management, the method comprising:
a. receiving new staffing requests from users via a new staffing request page;
b. creating job requirements for users;
c. receiving profiles from candidates;
d. matching the profiles with the job requirements;
e. providing an integrated interview scheduling feature in the staffing platform thereby allowing the candidates and the users to arrange interview times and/or locations;
f. providing an integrated calling and chatting feature in the staffing platform thereby allowing the candidates and the users to connect;
g. providing an expense management feature, based on candidate and/or user expenses;
h. tracking activities of the candidates and the users; and
i. providing updates to the candidates and the users, based on the tracking.

2. The method as claimed in claim 1, further comprising receiving a user account enrollment page.

3. The method as claimed in claim 1, wherein the user comprises a staffing supplier and/or a hiring entity.

4. The method as claimed in claim 3, wherein the staffing supplier comprises a recruiter.

5. The method as claimed in claim 1, wherein the new staffing request page further comprises providing a job requisition forwarding feature, allowing the users to forward job requisition details to other users in a secure manner.

6. The method as claimed in claim 1, further comprising providing an integrated calling and/or chatting feature in the staffing platform thereby allowing the candidates and the users to connect.

7. The method as claimed in claim 1, wherein the expense management feature further comprises information regarding expense approval status.

8. The method as claimed in claim 1, wherein the expense management feature further comprises information regarding an expense category.

9. The method as claimed in claim 8, wherein the expense category comprises candidate expense information related to food and/or hotel and/or gas and/or flight and/or uncategorized expenses.

10. The method as claimed in claim 1, wherein the integrated interview scheduling feature allows users to send up to five potential interview time slots to candidates.

11. The method as claimed in claim 1, wherein the integrated interview scheduling feature provides information regarding an interview category.

12. The method as claimed in claim 11, wherein the interview category comprises a phone interview and/or in-person interview.

13. A method for providing a staffing platform for automated job management, the method comprising:
receiving a user account enrollment page;
creating job requirements for users, wherein the user comprises a staffing supplier and/or a hiring entity;
receiving profiles from candidates;
receiving new staffing requests via a new staffing request page;
matching the profiles with the job requirements;
providing an integrated interview scheduling feature in the staffing platform thereby allowing the users to arrange the interview time and/or locations;
providing an expense management feature, based on candidate and/or user expenses;
providing an integrated calling and chatting feature in the staffing platform thereby allowing the candidates and the users to connect instantly;
tracking activities of the candidates and the users; and
providing updates to the candidates and the users, based on the tracking.

14. The method as claimed in claim 13, wherein the new staffing request page further comprises information regarding hourly billable rates.

15. The method as claimed in claim 13, wherein the new staffing request page further comprises information regarding the number of open positions.

16. The method as claimed in claim 13, wherein the integrated interview scheduling feature includes a follow-up tool in the staffing platform thereby allowing candidates and users to arrange a follow-up recruiter meeting time.

17. The method as claimed in claim 13, further comprising enabling the candidates to set their preferred times and/or locations for interaction with the users.

18. The method as claimed in claim 13, further comprising displaying real-time notifications to users without the need to log in to the application.

19. The method as claimed in claim 13, wherein the new staffing request page further comprises providing a job requisition forwarding feature, allowing the users to forward job requisition details to other users in a secure manner.

20. A staffing sourcing system comprising:
a. a server connected to a network, the server receiving requests from users via the network, the server comprising:
i. at least one processor;
ii. a database for storing trigger image information; and
iii. a memory operatively coupled to the processor, the memory storing program instructions that when executed by the processor, causes the processor to:
1. receive new staffing request from a user via the network;
2. determine logistical interview information generated from the candidate database based on the new staffing request; and
3. send potential interview times and locations to the user via the network.
